(19) United States
(12) Patent Application Publication
(10) Pub. No.: US 2012/0235867 A1
(43) Pub. Date: Sep. 20, 2012

(54) META-MATERIAL MIMO ANTENNA

(75) Inventors: Jongguk Kim, Seoul (KR); Jeonghoon Cho, Seoul (KR); Sungtek Kahng, Seoul (KR); Jakwon Ku, Seoul (KR); Kyungsuk Kim, Seoul (KR); Geonho Jang, Seoul (KR); Seongryong Yoo, Seoul (KR)

(73) Assignees: Incheon University Industry Academic Cooperation Foundation, Incheon (KR); LG Innotek Co., Ltd., Seoul (KR)

(21) Appl. No.: 13/420,126

(22) Filed: Mar. 14, 2012

(30) Foreign Application Priority Data
Mar. 14, 2011 (KR) 10-2011-0022358

(51) Int. Cl. H01Q 1/36

(52) U.S. Cl. 343/700 MS

(57) ABSTRACT

A meta-material MIMO antenna is disclosed, wherein the meta-material MIMO antenna includes a substrate; a first top radiator formed at one side of top surface of the substrate, and including an inner radiator and an outer radiator discrete from the inner radiator to encompass the inner radiator from outside; a second top radiator symmetrically formed against the first top radiator and formed on the other side of the top surface of the substrate; a first bottom radiator electrically connected to the first top radiator and formed on one side of bottom surface of the substrate; a second bottom radiator symmetrically formed against the first bottom radiator and formed on the other side of the bottom surface of the substrate; and a coupler remover interposed between the first and second bottom radiators, whereby the antenna can be miniaturized to enhance a high isolation.

### CROSS-REFERENCE TO RELATED APPLICATION

This application claims the benefit under 35 U.S.C. §119 of Korean Patent Application No. 10-2011-0022358, filed Mar. 14, 2011, which is hereby incorporated by reference in its entirety.

### BACKGROUND OF THE INVENTION

1. Field of the Invention

Exemplary embodiments of the present disclosure may relate to a meta-material MIMO (Multiple Input Multiple Output) antenna, and more particularly to a super small MIMO antenna interpolated by a meta-material structured SRR (Split Ring Resonator) radiator and a new coupler-removal structure.

2. Description of Related Art

An antenna has been gradually miniaturized and its structure has been also variably changed. Particularly, function of an antenna enabling wireless communication has been greatly enlarged due to rapid development of communication technologies, and miniaturization of wireless communication devices thus requires miniaturization of antenna size. Therefore, MIMO technology will become a mainstream technology in a wireless communication in the future. MIMO is a new and attractive approach to solve problems of wireless communication, such as attenuation of signals, increase of interference and restriction on spectrums.

Generally, an antenna needs a resonator, where a SRR (Split Ring Resonator) traditionally enables maximized utilization of space due to reduced size. Meanwhile, to implement a MIMO antenna system in a wireless portable terminal, two or more antenna elements should be disposed in a space smaller than half a wavelength, and thus it is difficult to improve an isolation characteristic. Since a plurality of antennas is used in a MIMO antenna system, interference may occur between the antennas. Thus, a radiation pattern may be distorted, or mutual coupling between antenna elements may occur.

If two SRR resonators are present in a neighboring space, the resonators relatively cause generation of deterioration of receipt sensitivity, such that additional structure is needed to remove the deterioration of receipt sensitivity.

However, size miniaturization of antennas is disadvantageously hampered due to the structure added to remove the deterioration of receipt sensitivity. That is, an antenna structure capable of miniaturizing an antenna system is required while removing the deterioration of SRR resonator.

### BRIEF SUMMARY

The present disclosure is proposed to solve the aforementioned disadvantages and it is an object to provide an antenna structure configured to remove degradation of SRR resonator and to implement miniaturization of antenna arrays.

Technical subjects to be solved by the present disclosure are not restricted to the above-mentioned description, and any other technical problems not mentioned so far will be clearly appreciated from the following description by the skilled in the art.

In one general aspect of the present disclosure, there is provided a meta-material MIMO antenna, comprising: a substrate; a first top radiator formed at one side of top surface of the substrate, and including an inner radiator and an outer radiator discrete from the inner radiator to encompass the inner radiator from outside; a second top radiator symmetrically formed against the first top radiator and formed on the other side of the top surface of the substrate; a first bottom radiator electrically connected to the first top radiator and formed on one side of bottom surface of the substrate; a second bottom radiator symmetrically formed against the first bottom radiator and formed on the other side of the bottom surface of the substrate; and a coupler remover interposed between the first and second bottom radiators.

Preferably, the inner radiator is configured in such a manner that a strip having a predetermined width is bent inward from predetermined points at both ends of the strip, and the both ends of the strip are not electrically connected.

Preferably, the outer radiator includes a top strip configured in such a manner that a strip having a predetermined width is bent inward from predetermined points at both ends of the strip to encompass the inner radiator, and a straight bottom strip having a predetermined width, wherein a part of the top strip is connected to one side of the bottom strip.

Preferably, the both ends of the top strip are not electrically connected.

Preferably, the other part of the bottom strip not connected to a part of the top strip at the first top radiator is electrically connected to the first bottom radiator via a via.

Preferably, the first bottom radiator is formed with a strip having a predetermined width and with lugs at a middle point and a distal end.

Preferably, the lug positioned at the middle point of the first bottom radiator is a feeding point.

Preferably, the lug positioned at the distal end of one side of the first bottom radiator is a short strip.

Preferably, a distal end of the other side of the first bottom radiator is electrically connected to a part of the first top radiator via a via.

Preferably, the coupler remover is configured in such a manner that a center of the first straight strip is connected by one side of a second straight strip, and both distal ends of the first straight strip are twice bent to a direction where the second straight strip is situated.

Preferably, both ends of the twice-bent first straight strip is not connected to the second straight strip.

### Advantageous Effects

The meta-material MIMO antenna according to the present disclosure has advantageous effect in that, unlike the conventional SRR, a SRR can be formed based on CRLH (Composite Left and Right Handed) meta-material structures and can maintain an antenna characteristic as a MIMO antenna as well. Meanwhile, miniaturization of an antenna can be implemented by inducing phase shift-free meta-material characteristic based on CRLH through intervals of strips, via and coupled strips thereof. Furthermore, a miniaturized MIMO antenna can be implemented through plane mushroom-cell structured coupler removal structure controlling a current flow in realizing a multiple feeding MIMO antenna using a miniaturized antenna.

### BRIEF DESCRIPTION OF THE DRAWINGS

The patent or application file contains at least one drawing executed in color. Copies of this patent or patent application publication with color drawings will be provided by the Patent Office upon request and payment of the necessary fee.

Accompanying drawings are included to provide a further understanding of arrangements and embodiments of the present disclosure and are incorporated in and constitute a part of this application. Now, non-limiting and non-exhaustive exemplary embodiments of the disclosure are described with reference to the following drawings, in which:

FIG. 1 is a circuit diagram illustrating a CRLH transmission line of meta-material structure according to prior art;

FIG. 2a is a schematic view illustrating a top pattern of a MIMO antenna according to an exemplary embodiment of the present disclosure;

FIG. 2b is a schematic view illustrating a bottom pattern of a MIMO antenna according to an exemplary embodiment of the present disclosure;

FIG. 3 is a schematic view illustrating a combined structure of a top pattern and a bottom pattern configured on one side of a substrate in a meta-material MIMO antenna according to an exemplary embodiment of the present disclosure;

FIG. 4 is a schematic view illustrating a current flow in a single antenna array;

FIG. 5 is a schematic view illustrating an electric field vector configuration in a single antenna in a single antenna array;

FIG. 6 is a schematic view illustrating an antenna configuration free from coupler remover;

FIG. 7 is a graph showing a scattering (S)-parameter characteristic free from coupler remover;

FIG. 8 is a schematic view illustrating a MIMO antenna configuration according to an exemplary embodiment of the present disclosure, where a coupler remover is present;

FIG. 9 is a schematic view illustrating an electric field vector configuration when a second antenna (200) of FIG. 8 is operable, in a MIMO antenna configuration according to an exemplary embodiment of the present disclosure;

FIG. 10 is a schematic view illustrating an electric field vector configuration when a first antenna (100) of FIG. 8 is operable, in a MIMO antenna configuration according to an exemplary embodiment of the present disclosure;

FIGS. 11 and 12 are schematic views illustrating a current flow in the first and second antennas (100, 200) of FIG. 8, in a MIMO antenna configuration according to an exemplary embodiment of the present disclosure;

FIG. 13 is a graph showing an actually measured S-parameter characteristic, in a MIMO antenna configuration according to an exemplary embodiment of the present disclosure; and

FIGS. 14 to 17 are schematic views illustrating radiation pattern, radiation efficiency and gain of an antenna measured by the first and second antennas of FIG. 8, in a MIMO antenna configuration according to an exemplary embodiment of the present disclosure.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the method particularly pointed out in the written description and claims hereof as well as the appended drawings.

### DETAILED DESCRIPTION

Hereinafter, exemplary embodiments of the present disclosure are described in detail with reference to the accompanying drawings. It will be appreciated that for simplicity and/or clarity of illustration, elements illustrated in the figure have not necessarily been drawn to scale. For example, the dimensions of some of the elements may be exaggerated relative to other elements for clarity. Further, if considered appropriate, reference numerals have been repeated among the figures to indicate corresponding and/or analogous elements.

Particular terms may be defined to describe the disclosure in the best mode as known by the inventors. Accordingly, the meaning of specific terms or words used in the specification and the claims should not be limited to the literal or commonly employed sense, but should be construed in accordance with the spirit and scope of the disclosure. The definitions of these terms therefore may be determined based on the contents throughout the specification.

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled”, and “connected” may mean that two or more elements do not contact each other but are indirectly joined together via another element or intermediate elements.

Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the following description and/or claims, the terms “comprise” and “include,” along with their derivatives, may be used and are intended as synonyms for each other. Furthermore, the terms “including”, “includes”, “having”, “has”, “with”, or variants thereof are used in the detailed description and/or the claims to denote non-exhaustive inclusion in a manner similar to the term “comprising”.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

In describing the present disclosure, detailed descriptions of constructions or processes known in the art may be omitted to avoid obscuring appreciation of the invention by a person of ordinary skill in the art with unnecessary detail regarding such known constructions and functions.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

Now, the meta-material MIMO antenna according to the present disclosure will be described in detail with reference to the accompanying drawings.

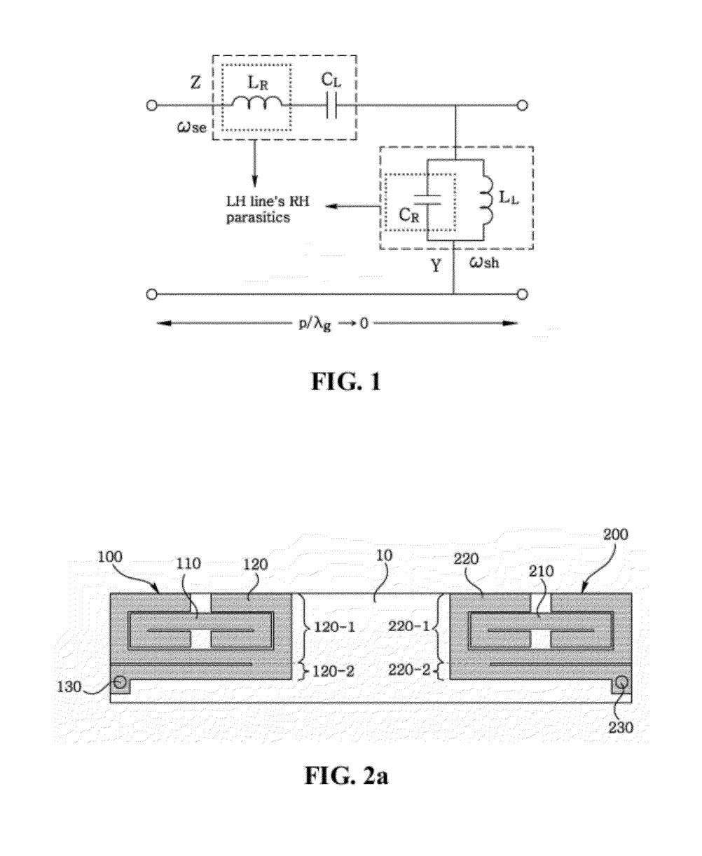

FIG. 1 is a circuit diagram illustrating a CRLH transmission line of meta-material structure according to prior art.

Generally, although wave number (wavelength) of an electromagnetic wave on a transmission line has a linearly increasing value as an operating frequency increases, the wave number on a CRLH transmission line of meta-material structure increases non-linearly. This property may be explained by being divided into a left-handed segment and a right-handed segment.

The left-handed propagation characteristic is such that an inclination of wave number at a particular frequency band is positive but has a negative value. If the wave number has a zero and a negative value, a resonant point is generated from the left-handed segment. Particularly, if the wave number is zero at a particular frequency band, wavelength becomes limitless to enable miniaturization regardless of structural resonant length.

As illustrated in FIG. 1, a CRLH (Composite Left and Right Handed) transmission line is constituted of series inductance (L_{R}), a series capacitance (C_{L}), and a parallel capacitance (C_{R}) and a parallel inductance (L_{L}), where the series inductance (L_{R}) and parallel capacitance (C_{R}) exhibit a right-handed characteristic, while the series capacitance (CO and the parallel inductance (L_{L}) exhibit a left-handed characteristic.

βₜₒₜₐₗ which is a phase speed of entire CRLH transmission line is determined by a sum of β of right-hand (R_{H}) segment, and β of left-hand (L_{H}) segment has a negative symbol. If βₜₒₜₐₗ has a zero value, meta-material free from phase shift is generated, if βₜₒₜₐₗ=0, wavelength is limitless to allow the transmission line and a resonator to have the same phase. Therefore, formation of electric field and electric field having shifts regardless of physical length is enabled, which leads to miniaturization of parts and a method of new property.

In the exemplary embodiment of the present disclosure, as illustrated in FIG. 1, in order to obtain properties of meta-material structured resonator, an MIMO antenna can satisfy the requirement of parallel inductance values and series capacitance values through via, interval among transmission lines and length.

The structure will be described in detail with reference to FIG. 3, and an entire structure of MIMO antenna according to an exemplary embodiment of the present disclosure will be explained now.

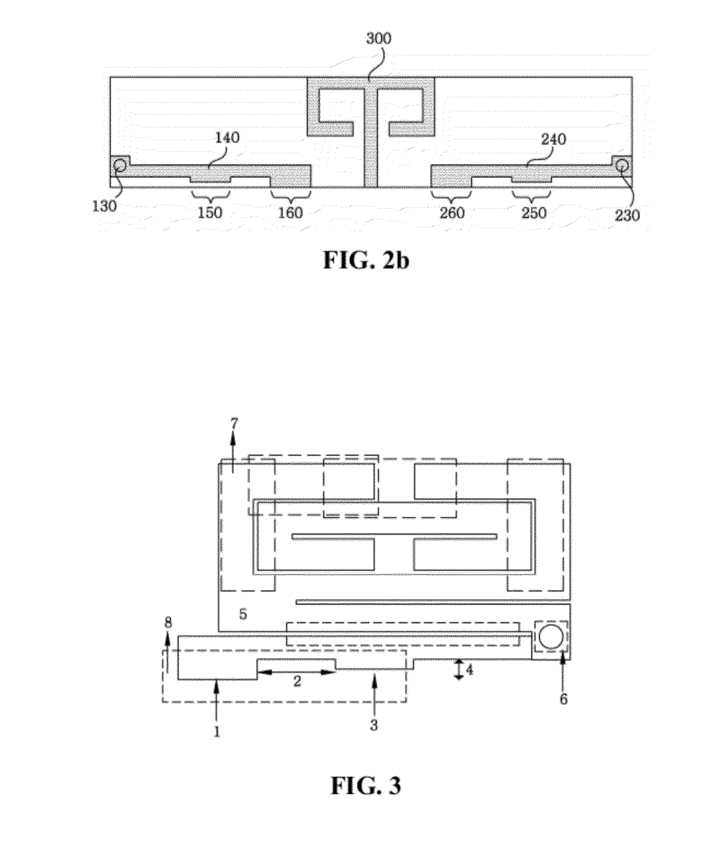

FIGS. 2a and 2b are schematic views illustrating an entire structure of a MIMO antenna according to an exemplary embodiment of the present disclosure, where FIG. 2a is a schematic view illustrating a top pattern of a MIMO antenna while FIG. 2b is schematic view illustrating a bottom pattern of a MIMO antenna.

Referring to FIG. 2a, one side and the other side of the top surface of a substrate (10) is formed with patterns, each symmetrical to the other. These patterns are defined as a first top radiator (100) and a second radiator (200). The second top radiator (200) has a pattern symmetrical to that of the first top radiator (100), and is discretely formed from the first top radiator (100) at a predetermined interval.

Thus, the structure of the first top radiator (100) is symmetrical to that of the second top radiator (200).

The first top radiator (100) formed at one side of top surface of the substrate includes an inner radiator (110), and an outer radiator (120) discrete from the inner radiator (110) to encompass the inner radiator (110) from outside.

The inner radiator (110) includes a strip having a predetermined width that is bent inward from predetermined points of both ends of the strip, where the both ends of the strip are not electrically connected.

Meanwhile, the outer radiator (120) includes a top strip (120-1) configured in such a manner that a strip having a predetermined width is bent inward from predetermined points at both ends of the strip to encompass the inner radiator, and a straight bottom strip (120-2) having a predetermined width, wherein a part of the top strip (120-1) is connected to one side of the bottom strip (120-2).

However, this configuration is arranged to provide an easy explanation, and in fact, the upper strip and the bottom strip are integrally formed. Furthermore, the both ends of the top strip (120-1) are not electrically connected and discrete from each other.

That is, the top strip (120-1) of outer radiator (120) takes the shape of the inner radiator (110) upside down.

Meanwhile, as illustrated in FIG. 2b, a bottom side of the substrate (10) is constituted of three elements. To be more specific, the bottom side of the substrate (10) includes a first bottom radiator (140), a second bottom radiator (240) and a coupler remover (300).

The first bottom radiator (140) is electrically connected to the first top radiator (100) via a via (130), and the second bottom radiator (240) is electrically connected to the second top radiator (200) via a via (230).

Now, the shape of each element forming the bottom side of the substrate (10) will be described.

The second bottom radiator (240) takes the shape of symmetrical to that of the first bottom radiator (140), and positioned at one side and the other side of the bottom side of the substrate (10). A bottom center radiator (300) is also formed at the bottom side of the substrate (10) and centrally interposed between the first bottom radiator (140) and second bottom radiator (240), where the first and second bottom radiators (140, 240) stay away from the bottom center radiator (300).

The first bottom radiator is formed with a strip having a predetermined width and lugs at a middle point and a distal end, where a lug (150) at a center of the first bottom radiator (140) is a feeding point, and a lug (160) at the distal end of the first bottom radiator (140) is a short strip.

Furthermore, the second bottom radiator (240) is also constituted of a strip having a predetermined width and with lugs at a center and a distal end, where a lug (250) at a center of the second bottom radiator (240) is a feeding point, and a lug (260) at the distal end of the second bottom radiator (240) is a short strip.

Meanwhile, the coupler remover (300) is configured in such a manner that a center of the first straight strip is connected by one side of a second straight strip, and both distal ends of the first straight strip are twice bent to a direction where the second straight strip is situated, where the both ends of the twice-bent first straight strip are discrete from and not connected to the second straight strip.

The meta-material MIMO antenna according to an exemplary embodiment of the present disclosure illustrated in FIGS. 2a and 2b can satisfy the requirement of parallel inductance values and series capacitance values through via, interval among transmission lines and length, in order to obtain properties of meta-material structured resonator of FIG. 1.

Now, an explanation will be provided on how a top pattern and a bottom pattern configured on one side of a substrate in a meta-material MIMO antenna according to an exemplary embodiment of the present disclosure satisfies the metamaterial structured resonator.

FIG. 3 is a schematic view illustrating a combined structure of a top pattern and a bottom pattern configured on one side of a substrate in a meta-material MIMO antenna according to an exemplary embodiment of the present disclosure.

Referring to FIG. 3, each length (5) of lines serves to obtain a series inductance (L_{R}), which is a core element for structurizing an SRR (Split Ring Resonator) in CRLH meta-material.

Furthermore, an interval between the inner radiator and the outer radiator in FIG. 3 helps to obtain a series capacitance (CO, which is a core element for structurizing the SRR (Split Ring Resonator) in CRLH meta-material.

A via (6) directly connected to a feed induces the series inductance (L_{R}) for structurizing the SRR (Split Ring Resonator) in CRLH meta-material.

Meanwhile, a discrete distance (9) between a bottom strip of outer radiator which is a constituent element of the top radiator and the bottom radiator is designed to reinforce the parallel capacitance (C_{R}) for structuring the SRR in CRLH meta-material. Furthermore, a discrete distance between the two lugs formed on the bottom radiator, i.e., a lug for short line and a lug of feeding point, serves to adjust input impedance.

The configuration of feeding point and short line serves to satisfy antenna bandwidth and serves as a stub for matching input impedance. At the same time, the configuration helps to reinforce the parallel capacitance (C_{R}), which is a core element for structurizing the SRR in CRLH meta-material. The parameter value can obtain characteristic of meta-material structure that cannot be seen in the conventional SRR.

FIG. 4 is a schematic view illustrating a current flow in a single antenna array. The single antenna includes a dimensional size of 10 mm (width)×5 mm (length)×2 mm (height), and miniaturized to 0.08λ, relative to the length, reducing to ½ the size of modified monopole antenna that uses the conventional MIMO antenna.

Meanwhile, although there are many methods for checking meta-material characteristic of an antenna free from phase shift may include antenna radiation pattern, electric field vector and current flow methods, the electric field vector method will be described herein.

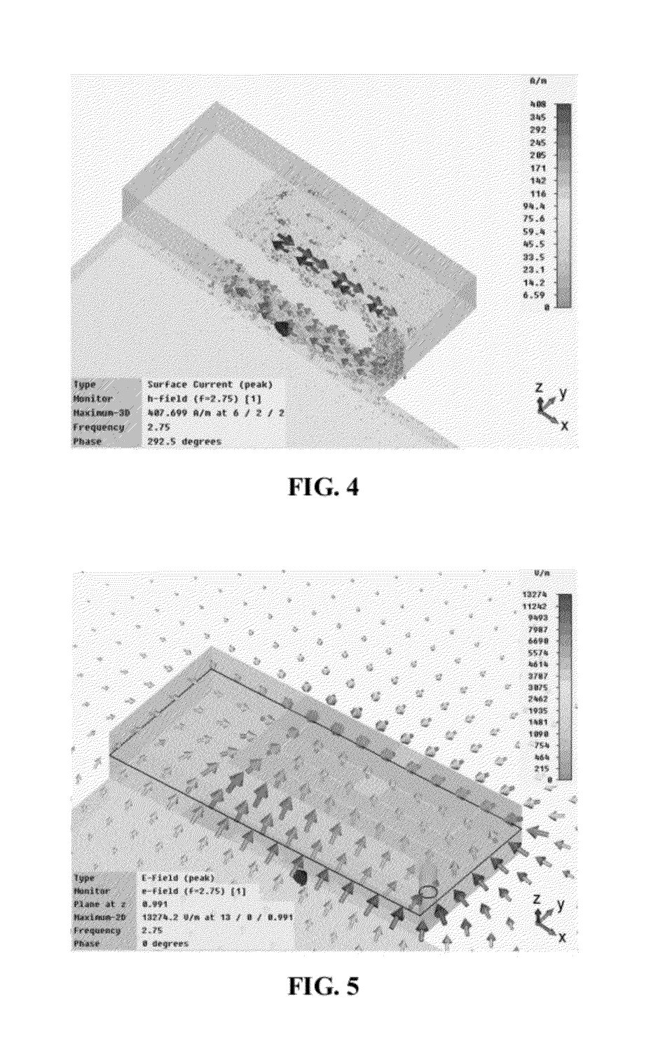

FIG. 5 is a schematic view illustrating an electric field vector configuration in a single antenna in a single antenna array.

An electric vector is changed to 180 degrees in a half-wave length resonant area in light of a conventional antenna characteristic, whereby a current flows in an opposite direction. In case of a meta-material antenna free from phase shift, an electric vector is formed to the same direction on an entire antenna area, such that a current flows to the same direction. That is, it can be noted that all the electric vectors formed in the single antenna array are formed to the same direction through which the antenna is characterized by being free from phase shift change.

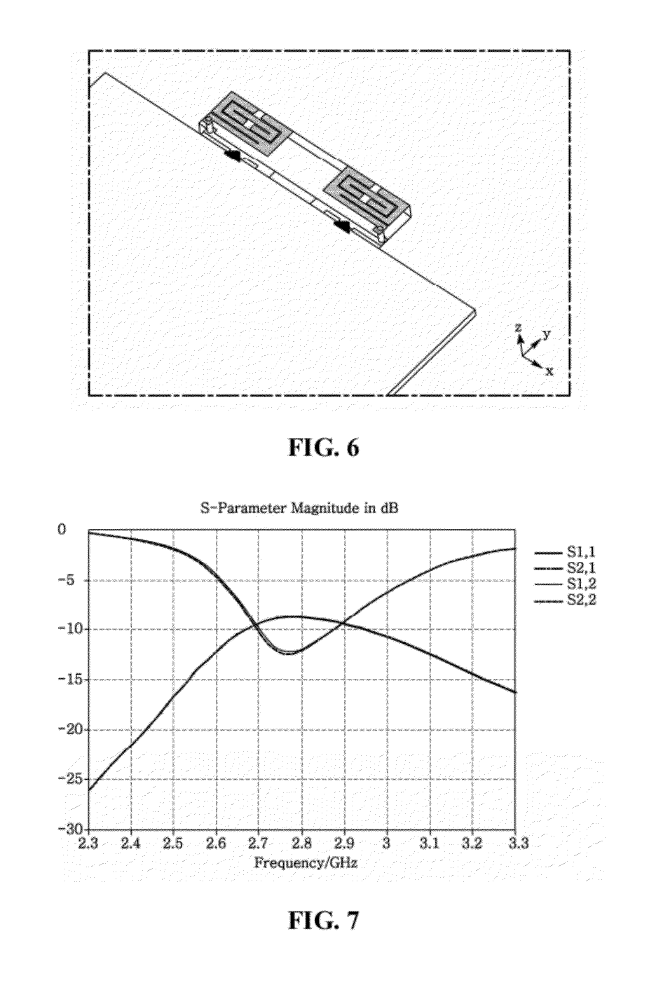

FIG. 6 is a schematic view illustrating an antenna configuration free from coupler remover, FIG. 7 is a graph showing a scattering (S)-parameter characteristic free from coupler remover, and particularly FIG. 7 illustrates S-parameter in antenna configuration of FIG. 6.

In view of isolation characteristic illustrated in FIG. 7, it can be noted that an isolation characteristic is not good when the antenna in FIG. 6 is actually measured using −8 dB in simulations. That is, the isolation characteristic decreases dramatically even in the case of absence of coupler remover.

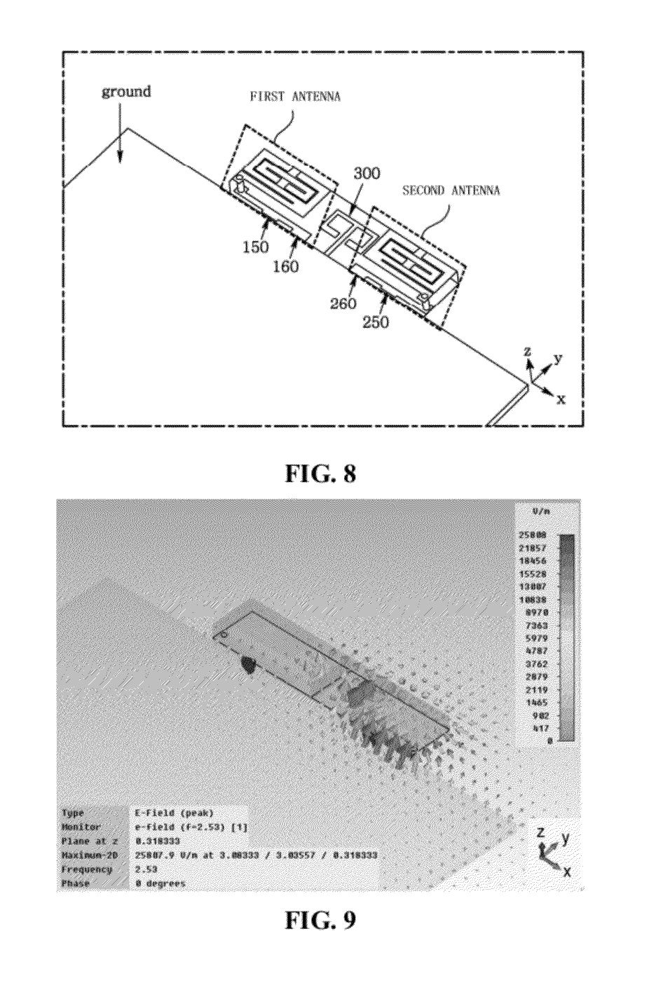

FIG. 8 is a schematic view illustrating a MIMO antenna configuration according to an exemplary embodiment of the present disclosure, where a coupler remover is present unlike FIG. 6. That is, FIG. 8 illustrates a meta-material MIMO antenna according to an exemplary embodiment of the present disclosure that is formed with the coupler remover.

Referring to FIG. 8, the meta-material MIMO antenna according to an exemplary embodiment of the present disclosure includes a first antenna including a feeding point (150) and a short line (160), and a second antenna including a second phase feeding point (250) and a short line (160), where a coupler remover (300) is formed in discreteness on center of the second antenna, and where the first antenna includes a first top radiator (100) and a first bottom radiator (140), and the second antenna includes the second top radiator (200) and the second bottom radiator (240).

The coupler remover (300) in which a mushroom cell structure is simplified as in the meta-material MIMO antenna according to an exemplary embodiment of the present disclosure is designed to have distal end bent to obtain a parallel capacitance and a series inductance to meet the requirement of bandwidth.

FIG. 9 is a schematic view illustrating an electric field vector configuration when a second antenna (200) of FIG. 8 is operable, in a MIMO antenna configuration according to an exemplary embodiment of the present disclosure. It can be verified that same electric field vector is included across the entire antenna as in FIG. 3.

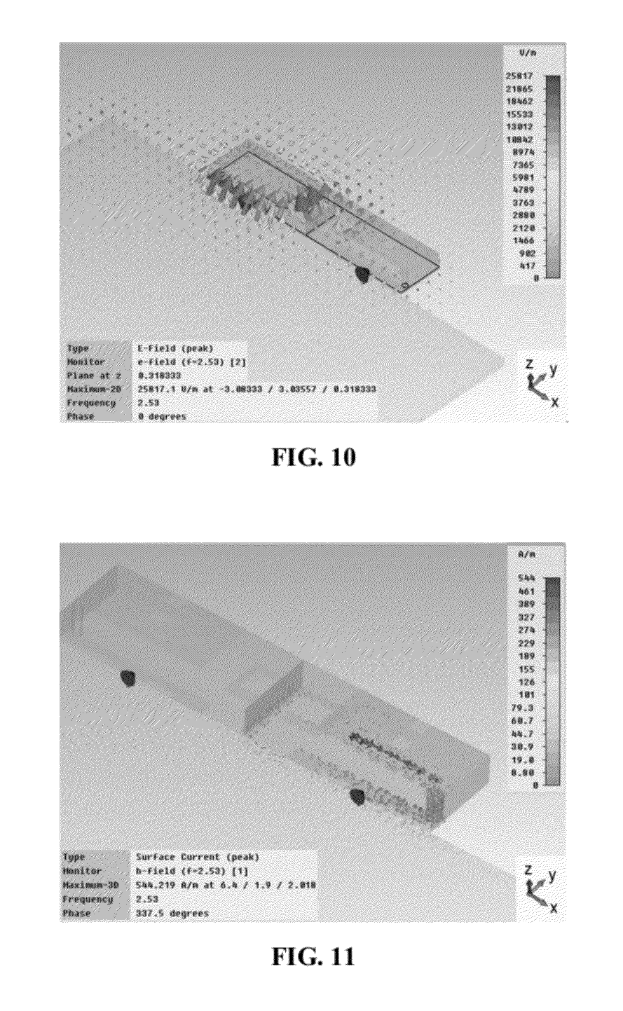

FIG. 10 is a schematic view illustrating an electric field vector configuration when a first antenna (100) of FIG. 8 is operable, in a MIMO antenna configuration according to an exemplary embodiment of the present disclosure, where it can be noted that the electric field vector configuration is same as that in FIG. 9, which is the same characteristic as shown in a single antenna array. The explanation of SRR where the first and second antennas of FIG. 8 are applied to a single antenna array may be equally interpreted by explanation of each parameter structurizing the SRR (Split Ring Resonator) in CRLH meta-material.

In viewing sizes of electric field vectors in FIG. 9 and FIG. 10, a smaller size of vector in an antenna positioned in an opposite direction may be interpreted as blocking the interference by influence of the coupler remover (300) of FIG. 8.

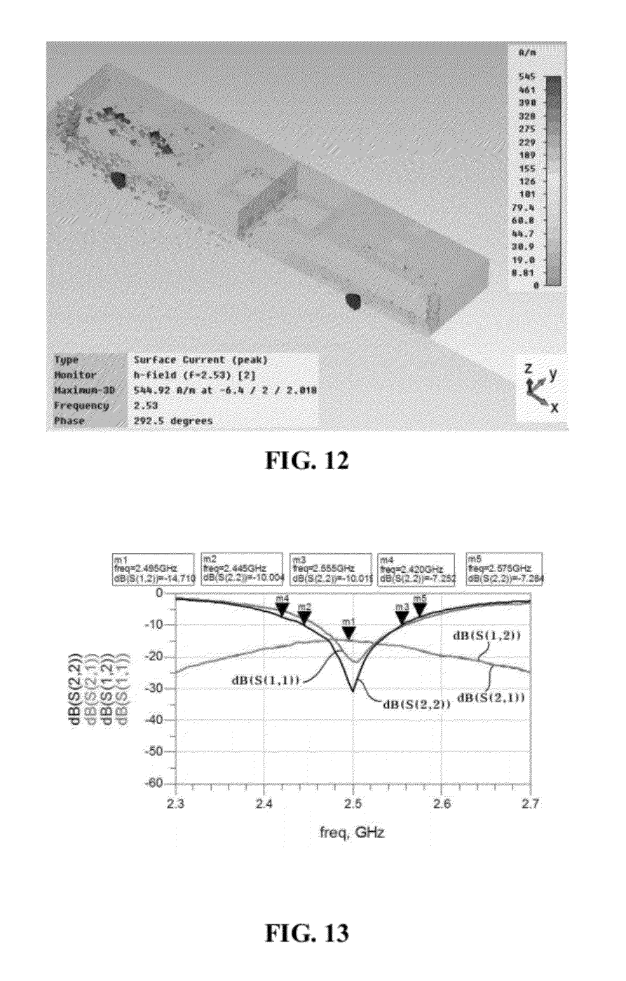

FIGS. 11 and 12 are schematic views illustrating a current flow in the first and second antennas (100, 200) of FIG. 8, in a MIMO antenna configuration according to an exemplary embodiment of the present disclosure.

The flow of current in other antennas except for an operating antenna can hardly be checked, which is caused by the coupler remover (300) that blocks a current flowing to opposite antenna. Through these characteristics, the interference of each antenna is reduced to enhance an isolation characteristic.

FIG. 13 is a graph showing an actually measured S-parameter characteristic, in a MIMO antenna configuration according to an exemplary embodiment of the present disclosure.

As shown in FIG. 12, an isolation characteristic between the first and second antennas shows −14 dB. That is, it can be noticed that the isolation characteristic has been much improved over −8 dB that is shown in FIG. 7 illustrating an S-parameter of FIG. 6 designed with an isolation distance of 6 mm free from the coupler remover (300).

In short, the interference among antennas can be reduced by function of coupler removing structure using the coupler remover (300) in the meta-material MIMO antenna according to an exemplary embodiment of the present disclosure, whereby efficiency of each antenna can be maintained as in the single antenna array.

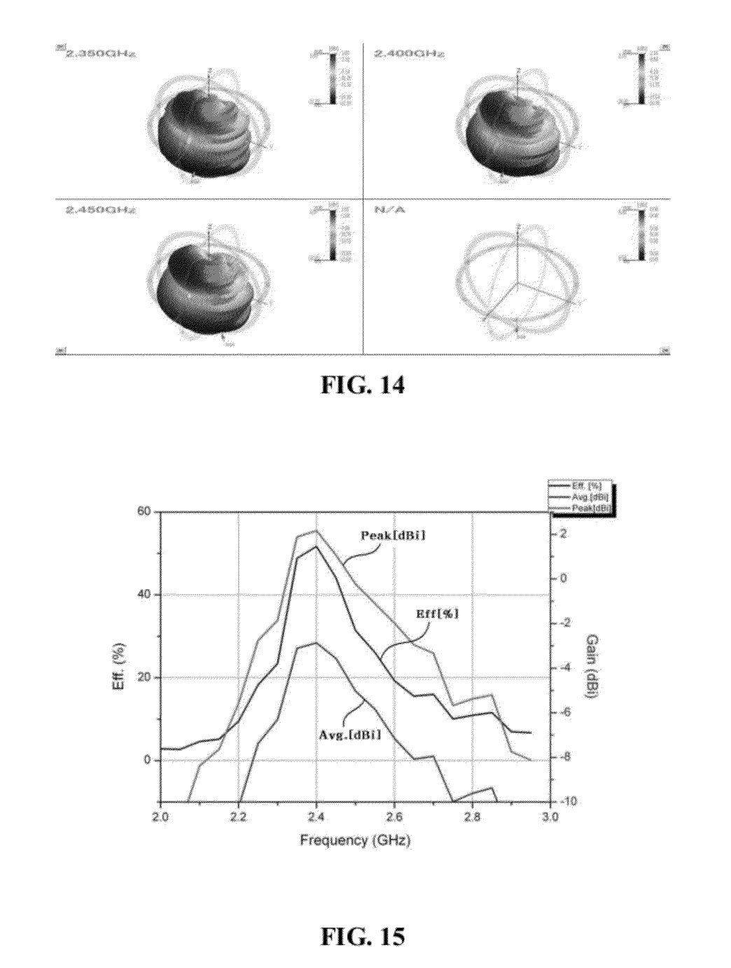

FIGS. 14 to 17 are schematic views illustrating radiation pattern, radiation efficiency and gain of an antenna measured by the first and second antennas of FIG. 8, in a MIMO antenna configuration according to an exemplary embodiment of the present disclosure.

FIGS. 14 and 15 illustrate a radiation characteristic of first antenna in FIG. 8, where it can be noticed that efficiency in the center frequency of an antenna is more than 50%.

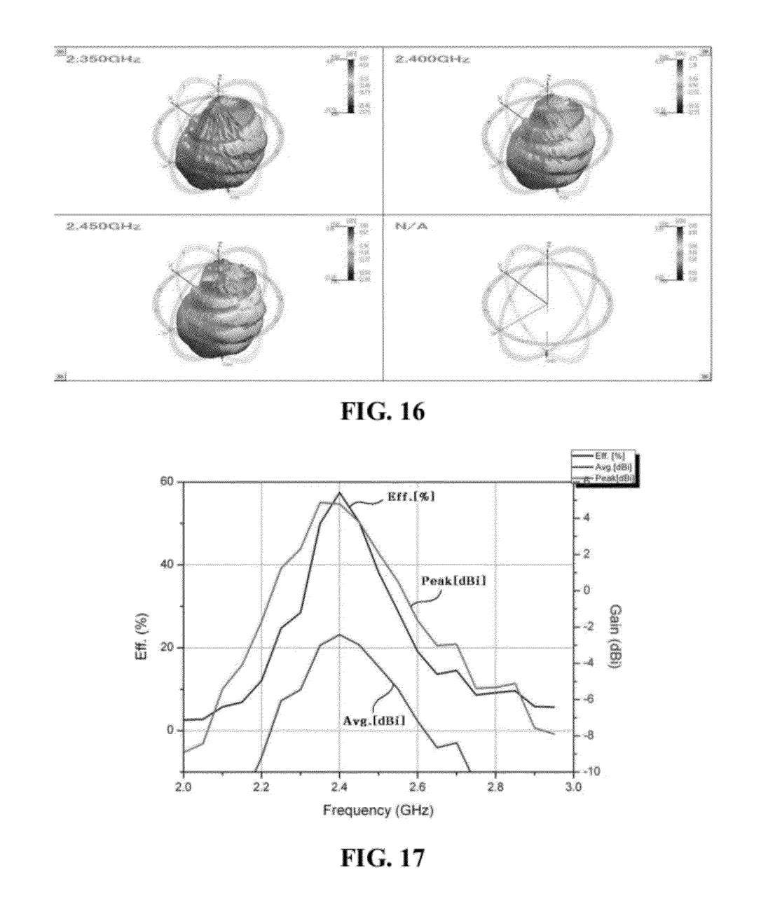

FIGS. 16 and 17 illustrate a radiation characteristic of second antenna in FIG. 8, where it can be noticed that efficiency in the center frequency of an antenna is more than 60%.

The MIMO antenna including an isolation structure is miniaturized to a dimensional size of 26 mm (width)×5 mm (length)×2 mm (height). Meanwhile, a width of the coupler remover (300) is 6 mm, which shows that there is no change in size of antenna.

The meta-material MIMO antenna according to the present disclosure may, however, be embodied in many different forms and should not be construed as limited to the embodiments set forth herein. Thus, it is intended that embodiments of the present disclosure may cover the modifications and variations of this disclosure provided they come within the scope of the appended claims and their equivalents.

While particular features or aspects may have been disclosed with respect to several embodiments, such features or aspects may be selectively combined with one or more other features and/or aspects of other embodiments as may be desired.

What is claimed is:

1. A meta-material MIMO antenna, comprising:
a substrate;
a first top radiator formed at one side of top surface of the substrate, and including an inner radiator and an outer radiator discrete from the inner radiator to encompass the inner radiator from outside;
a second top radiator symmetrically formed against the first top radiator and formed on the other side of the top surface of the substrate;
a first bottom radiator electrically connected to the first top radiator and formed on one side of bottom surface of the substrate;
a second bottom radiator symmetrically formed against the first bottom radiator and formed on the other side of the bottom surface of the substrate; and
a coupler remover interposed between the first and second bottom radiators.

2. The meta-material MIMO antenna of claim 1, wherein the inner radiator is configured in such a manner that a strip having a predetermined width is bent inward from predetermined points at both ends of the strip, and the both ends of the strip are not electrically connected.

3. The meta-material MIMO antenna of claim 1, wherein the outer radiator includes a top strip configured in such a manner that a strip having a predetermined width is bent inward from predetermined points at both ends of the strip to encompass the inner radiator, and a straight bottom strip having a predetermined width, wherein a part of the top strip is connected to one side of the bottom strip.

4. The meta-material MIMO antenna of claim 3, wherein the both ends of the top strip are not electrically connected.

5. The meta-material MIMO antenna of claim 3, wherein the other part of the bottom strip not connected to a part of the top strip at the first top radiator is electrically connected to the first bottom radiator via a via.

6. The meta-material MIMO antenna of claim 1, wherein the first bottom radiator is formed with a strip having a predetermined width and with lugs at a middle point and a distal end.

7. The meta-material MIMO antenna of claim 6, wherein the lug positioned at the middle point of the first bottom radiator is a feeding point.

8. The meta-material MIMO antenna of claim 6, wherein the lug positioned at the distal end of one side of the first bottom radiator is a short strip.

9. The meta-material MIMO antenna of claim 6, wherein a distal end of the other side of the first bottom radiator is electrically connected to a part of the first top radiator via a via.

10. The meta-material MIMO antenna of claim 1, wherein the coupler remover is configured in such a manner that a center of the first straight strip is connected by one side of a second straight strip, and both distal ends of the first straight strip are twice bent to a direction where the second straight strip is situated.

11. The meta-material MIMO antenna of claim 10, wherein both ends of the twice-bent first straight strip is not connected to the second straight strip.
